(19) United States
(12) Patent Application Publication
(10) Pub. No.: US 2020/0004892 A1
(43) Pub. Date: Jan. 2, 2020

(54) TECHNIQUES FOR DYNAMICALLY DESIGNING PRODUCTS VIA USER FEEDBACK

(71) Applicant: Erik Brisson, Rehoboth, MA (US)

(72) Inventor: Erik Brisson, Rehoboth, MA (US)

(73) Assignee: Erik Brisson, Rehoboth, MA (US)

(21) Appl. No.: 16/451,466

(22) Filed: Jun. 25, 2019

Related U.S. Application Data
(60) Provisional application No. 62/691,254, filed on Jun. 28, 2018.

(51) Int. Cl. G06F 17/50

(52) U.S. Cl. CPC G06F 17/50; G06F 2217/12

(57) ABSTRACT

Techniques for dynamically designing products, which may include consumer products, based on feedback provided by a user are provided. According to some aspects, a system may present a dynamically designed instance of a product to a user and obtain feedback from the user indicating a degree to which the user likes the product design. Based on this feedback, the system may present another dynamically designed instance of the product and again obtain feedback from the user. In this manner, the system may gather information on the preferences of the user and iteratively design an instance of the product that is aligned with those preferences. In some cases, the user may effectively be selecting product options that would be difficult or impossible to present to the user because they may be non-representational in quality.

### CROSS-REFERENCE TO RELATED APPLICATIONS

The present application claims the benefit under 35 U.S.C. § 119(e) of U.S. Provisional Patent Application No. 62/691,254, filed Jun. 28, 2018, titled “Techniques for Dynamically Designing Products Via User Feedback,” which is hereby incorporated by reference in its entirety.

### BACKGROUND

Consumer products are typically designed by an individual or team based on both aesthetic and technical considerations. Designers select physical shapes for various features of the product based on their intuition and creativity, while also considering the materials and production processes through which the product will be made. It is frequently desirable to design a new product that is similar in form and function to an earlier-designed product. Despite their similarities, however, new products are typically designed using much the same process as for the earlier product, insomuch that designers once again intuitively decide upon the form whilst considering technical aspects of the product.

### SUMMARY

A computer-implemented method of dynamically designing a product according to a product pattern, the product pattern describing a product based on a plurality of parameters, the method comprising selecting, using at least one processor, values for each of the plurality of parameters of the product pattern, said selecting including selecting an initial value for a first parameter of the plurality of parameters based on a first probability distribution of possible values for the first parameter, the first probability distribution being defined at least in part by a plurality of feedback scores each associated with the possible values for the first parameter, generating, using the at least one processor, a first product design according to the product pattern and based on the selected initial value for the first parameter, presenting, using the at least one processor, the first product design to a user via a user interface, receiving input, using the at least one processor, from the user via the user interface indicating a favorable or unfavorable opinion with respect to the first product design, adjusting, using the at least one processor, at least one of the plurality of feedback scores based on the received input, and selecting, using the at least one processor, a subsequent value for the first parameter of the plurality of parameters based on a second probability distribution of possible values for the first parameter, the second probability distribution being defined at least in part by the plurality of feedback scores as adjusted based on the received input.

At least one non-transitory computer readable medium comprising instructions that, when executed by at least one processor, perform a method of dynamically designing a product according to a product pattern, the product pattern describing a product based on a plurality of parameters, the method comprising selecting values for each of the plurality of parameters of the product pattern, said selecting including selecting an initial value for a first parameter of the plurality of parameters based on a first probability distribution of possible values for the first parameter, the first probability distribution being defined at least in part by a plurality of feedback scores each associated with the possible values for the first parameter, generating a first product design according to the product pattern and based on the selected initial value for the first parameter, presenting the first product design to a user via a user interface, receiving input from the user via the user interface indicating a favorable or unfavorable opinion with respect to the first product design, adjusting at least one of the plurality of feedback scores based on the received input, and selecting a subsequent value for the first parameter of the plurality of parameters based on a second probability distribution of possible values for the first parameter, the second probability distribution being defined at least in part by the plurality of feedback scores as adjusted based on the received input.

A system, comprising at least one processor, at least one non-transitory computer readable medium comprising instructions that, when executed by the at least one processor, perform a method of dynamically designing a product according to a product pattern, the product pattern describing a product based on a plurality of parameters, the method comprising selecting values for each of the plurality of parameters of the product pattern, said selecting including selecting an initial value for a first parameter of the plurality of parameters based on a first probability distribution of possible values for the first parameter, the first probability distribution being defined at least in part by a plurality of feedback scores each associated with the possible values for the first parameter, generating a first product design according to the product pattern and based on the selected initial value for the first parameter, presenting the first product design to a user via a user interface, receiving input from the user via the user interface indicating a favorable or unfavorable opinion with respect to the first product design, adjusting at least one of the plurality of feedback scores based on the received input, and selecting a subsequent value for the first parameter of the plurality of parameters based on a second probability distribution of possible values for the first parameter, the second probability distribution being defined at least in part by the plurality of feedback scores as adjusted based on the received input.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a flowchart of a method of dynamically designing an object based on user feedback, according to some embodiments;

FIG. 2 is a flowchart of a method of producing a product pattern and producing a desired end product based on user preferences, according to some embodiments;

FIGS. 3A-3B depict two-dimensional shapes defined by four interconnected parameterized curves, according to some embodiments;

FIGS. 4A-4B depict illustrative product designs comprising the shapes illustrated in FIGS. 3A-3B, according to some embodiments;

FIG. 5A depicts adjustable spatial attributes of a product, according to some embodiments;

FIGS. 5B-5D depict product designs of the product shown in FIG. 5A with various values of the adjustable spatial attributes, according to some embodiments;

FIG. 6 depicts an illustrative probability distribution for product pattern parameters being updated based on user feedback, according to some embodiments;

FIG. 7 depicts an illustrative graphical user interface for a user to provide feedback on a design of a product, according to some embodiments; and

FIG. 8 is a schematic of a computing device suitable for use in performing embodiments of the present invention.

### DETAILED DESCRIPTION

Conventionally, some consumer products can be purchased by selecting from amongst various product options. By selecting desired combinations of these options, the product can be tailored to fit a consumer's preferences. Such options typically allow independent selection from features such as sizes, colors, and the inclusion or exclusion or particular elements. Such a process depends on the user to evaluate and decide on a selection for each option, and is therefore limited to presenting clear, easily understandable variations in product characteristics. Moreover, this process generally does not allow variation of the aesthetic form of the product, except in cases where a user can select from a preset list of different predesigned models of a product.

For example, a consumer looking to purchase a chair would typically begin by selecting the size and shape of the chair from amongst a handful of different chairs presented by a manufacturer, each of which has been independently designed in advance. The consumer may then select from various additional options, such as fabric coverings for the chair, wood color, metal color, etc. to arrive at a desired product. While a certain amount of choice is afforded to the consumer through this process, the consumer is nonetheless selecting one product from amongst a number of predesigned products.

The inventor has recognized and appreciated techniques for dynamically designing products, which may include consumer products, based on feedback provided by a user. A system may present a dynamically designed instance of a product to a user and obtain feedback from the user indicating a degree to which the user likes (or does not like) the product design. Based on this feedback, the system may present another dynamically designed instance of the product and again obtain feedback from the user. In this manner, the system may gather information on the preferences of the user and iteratively design an instance of the product (a “product design”) that is aligned with those preferences. Through this process, the user may effectively be selecting product options that would be difficult or impossible to present to the user because they may be non-representational in quality. Yet, because the user provides feedback on a product design as a whole, the system may learn which attributes of product designs the user likes and does not like.

According to some embodiments, products may be dynamically designed by the system according to a parameterized blueprint of the product. Such a blueprint, referred to herein as a “product pattern,” defines a design of a product that adheres to certain guidelines or boundaries whilst being configurable in a variety of ways. Parameters of a product pattern may include spatial attributes, such as a size of a feature, and/or parameters that control multiple attributes, such as a parameter which describes the smoothness of the product.

According to some embodiments, preference data may be stored by the system that indicate relative preferences for different values of a parameter of a product pattern. Such preference data may be updated based on user feedback on a product design by adjusting the stored measure of relative preference for a value of a parameter when the product design was produced using that value for that parameter. When generating a new design for a product pattern, the relative preference data for values of parameters of that design may be considered in order to generate a design that favors the previously demonstrated preferences of the user.

For instance, a product pattern may include a parameter that controls the smoothness of a surface of the product, wherein some values of the parameter will produce product designs that are more smooth and wherein some values of the parameter will produce product designs that are less smooth. When a user provides feedback (e.g., provides a negative or positive opinion) on product designs that are generated with particular values of this parameter, data representing the feedback to date (referred to hereafter as feedback “scores”) may be stored in association with those values. Subsequently, when generating a new design of the product, values of the parameter associated with more positive feedback scores may be more likely to be selected, whereas values of the parameter associated with less positive feedback (or no feedback) may be less likely to be selected. The net result may be, for example, that the system is more likely to generate new product designs that have a comparatively higher level of smoothness when the user more frequently expresses positive feedback for product designs with a comparatively higher level of smoothness than for product designs with a comparatively lower level of smoothness.

According to some embodiments, user feedback for a product design may take various forms, including but not limited to a positive or negative response (e.g., “thumbs up” or “thumbs down”) or a score indicating the extent to which the user likes the product design (e.g., “rate this design out of 10”). Irrespective of the form of user feedback, the system may in response adjust feedback scores associated with values of one or more parameters of the product design. Feedback scores may be adjusted in view of positive feedback only, in view of negative feedback only, or in view of both positive or negative feedback. In some embodiments, adjustments to feedback scores may be inferred from other user actions. For instance, when a user purchases a product design it implies, even in the absence of direct feedback, that the user views this product design favorably and the system may adjust one or more feedback scores accordingly.

According to some embodiments, the system may generate instructions for fabrication of a product design when instructed to do so by a user (e.g., when the user has indicated they wish to purchase the product design). In some cases, such instructions may indicate to a manufacturer how to manufacture the product design. For instance, blueprints and/or numerical specifications may be generated and provided to a manufacturer. In some cases, instructions may comprise programmatic instructions to be executed by one or more automated fabrication devices, such as one or more 3d printers, laser cutters, 2d printers, and/or Computer Numerical Control (CNC) systems. This may allow part or all of the product design to be fabricated automatically. In some embodiments, the system may generate digital assets relating to a product design when instructed to do so by a user. For instance, the system may generate one or more digital models representing the product design.

According to some embodiments, a system for dynamically designing products based on feedback provided by a user may include a client application accessed by a user to view product designs and provide feedback on those product designs, and a server to access preference data associated with the user and to generate product designs based on the preference data. Such a client application may take any suitable form, including a desktop computer application, a thin client application, a mobile device app, etc.

Following below are more detailed descriptions of various concepts related to, and embodiments of, techniques for dynamically designing products based on feedback provided by a user. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

In the description below, references are made to a “user” of a system for dynamically designing products. It will be appreciated that the user may or may not be a consumer or shopper accessing the system with a goal of potentially purchasing a product, as the techniques described herein are not limited in this regard. For example, in some cases a user may be designing a product for their own use, or may be accessing the system on behalf of another person. References to a “user” below are therefore not intended to limit the user to any particular type of user nor any particular goal of the user. Moreover, it should be appreciated that a “user” need not be a single individual, and that in some embodiments, actions attributable to a “user” may be performed by a team of individuals and/or an individual in combination with computer-assisted tools or other mechanisms.

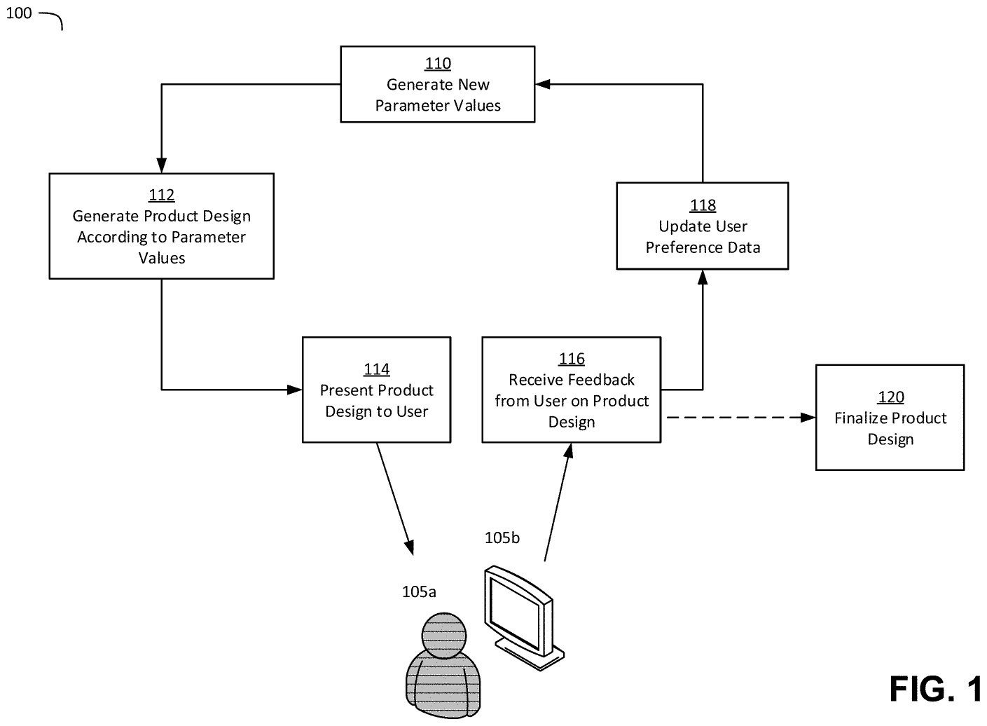

FIG. 1 is a flowchart of a method of dynamically designing an object based on user feedback, according to some embodiments. Method 100 illustrates an iterative process of designing a product through the loop represented by acts 110, 112, 114, 116 and 118, facilitated in part by feedback provided by user 105a via client interface 105b. The iterative process may continue until input from the user 105a indicates a current product design is to be finalized in act 120.

According to some embodiments, method 100 may begin in act 110 in which a set of parameter values are generated for a given product pattern. As discussed above, a product pattern is a parameterized blueprint of a product that allows designs of the product to adhere to certain guidelines or boundaries whilst also being configurable in a variety of ways. Henceforth, a given set of values selected for the parameters of a product pattern may be referred to as an “item key.” According to some embodiments, a product pattern may specify a finite number of possible values for at least some, and in some cases all, parameters of the product pattern. According to some embodiments, a product pattern may specify a range of possible values for at least some, and in some cases all, parameters of the product pattern such that these parameters may have any value within the defined range. Irrespective of how the product pattern specifies the possible values of parameters of the product pattern, generation of a product design from a product pattern may comprise selecting, for each parameter of the product pattern, one of the possible values as specified for the parameter.

According to some embodiments, one or more parameters of a product pattern may relate directly to a size and/or shape of a particular region of the associated product. As non-limiting examples, such parameters may be indicative of a length, a width, a height, a radius (e.g., of a sphere, of curvature), a surface normal, a surface tangent, a position in a 2- or 3-dimensional space, a surface area, an aspect ratio (e.g., ratio of width to height), a number of splines defining a curve, a number of points defining a curve, a number of inflection points of a curve, etc. As discussed above, a product pattern may specify possible values for each parameter of the product pattern. By specifying such values, a creator of a product pattern may thereby restrict the size and/or shape of particular regions of the product as desired.

According to some embodiments, one or more parameters of a product pattern may indirectly relate to sizes and/or shapes of some regions, or all regions, of the associated product. Such parameters may be referred to herein as “meta-parameters.” In some cases, a meta-parameter may reflect a visual characteristic of the product, variation of which may adjust a number of different sizes and/or shapes of regions of the product. For instance, a meta-parameter may control the “pointiness” of some or all of the product design by, for example, controlling the extent to which one or more curves within the product design exhibit hard changes versus more gentle changes. As another example, a meta-parameter may control the complexity of a shape within the product design by controlling a number of curve segments that define the shape. Other examples of meta-parameters may include curviness and smoothness, although it will be appreciated that some meta-parameters may affect physical aspects of a product design where there is no corresponding term like “smoothness” because some meta-parameters may reflect non-representational attributes of a product design.

In some cases, a meta-parameter may define, at least in part, a probability distribution from which an attribute of the product design may be sampled. In some cases, multiple meta-parameters of a product pattern may together define such a probability distribution. For instance, the value of a first meta-parameter may indicate a lower bound of a length and the value of a second meta-parameter may indicate an upper bound of the length. The length for a product design may be selected by randomly sampling a length value between the defined upper and lower bounds. More complex examples may also be envisioned, such as defining a Gaussian probability distribution by meta-parameters that control the mean and variance of the distribution, and where a parameter value is selected from that probability distribution.

According to some embodiments, values may be selected for parameters of the product pattern based at least in part on data describing the preferences of current user 105a. Such preference data may be stored in any suitable location and may be associated with a user account of user 105a. In some embodiments, preference data may include feedback scores associated with a particular product pattern and the user 105a. Each feedback score may be associated with a particular value of a particular parameter of the product pattern. The feedback scores thereby identify the extent to which the user has expressed a preference for particular values of the parameters of the product pattern. Such feedback scores may have been produced through one or more iterations through acts 110, 112, 114, 116 and 118 as will be described below, or may represent initial feedback scores generated prior to obtaining input from the user 105a.

In some embodiments, preference data may include indications of a user's preferences that are independent of any particular product pattern. Such indications may be stored separately from feedback scores relating to a particular product pattern and/or may be produced according to such feedback scores. These indications may represent higher level descriptions of the user's tastes and preferences, such as the types of products the user has a preference for and/or the visual characteristics that the user has a preference for (e.g., whether or not the user has a preference for angular shaped products). Such indications may be specified based on product types; for instance, preferences relating to furniture products may be indicated independently of preferences relating to clothing products. Higher level preference data such as the aforementioned data may be beneficial in performing market research on certain products or types of products.

According to some embodiments, an initial selection of parameter values in act 110 for a product pattern may be specified by the product pattern. That is, the parameter values selected in act 110 before any feedback has been obtained from the user 105a with respect to the product pattern. In some embodiments, such an initial selection may be selected by randomly sampling from possible values of a parameter wherein each value of the parameter is equally likely to be chosen. This approach may produce a “random” set of parameter values whilst conforming to the parameter values allowed by the product pattern.

Subsequent to selection of the parameter values in act 110, a product design is generated in act 112 according to the selected values of the parameters. This generation step may take various forms, depending on how the product pattern is defined. In some embodiments, a product pattern may programmatically generate a representation of the product design using parameter values as input. For example, a product pattern may comprise instructions that, when executed, generate a 2- or 3-dimensional model of a product design based on the selected parameter values.

In act 114, the product design generated in act 112 is presented to a user 105a through client interface 105b. In some embodiments, such presentation may comprise displaying a visual representation of the product design to the user through a graphical user interface (GUI). Such a GUI may display a 2-dimensional and/or a 3-dimensional view of the product design. In some cases, the GUI may be configured to enable a user to manipulate the GUI to adjust the view of the product design (e.g., zooming, panning, rotating, etc. the view). Such manipulation may be performed, for example, through touch (e.g., when client interface 105b is a mobile device app) or using an input device such as a mouse (e.g., when client interface 105b is presented via a desktop computer).

In act 116, the system receives input from user 105a via the client interface 105b indicating an extent to which the user likes or does not like the presented product design. Such input may reflect a simple “like” or “dislike” of the product design, or may reflect one of several degrees of preference, such as a score out of 10. This input may be provided in a number of ways, including by activating a button in a GUI or by, in a mobile device app, “swiping” a representation of the product design in a direction that indicates a favorable or unfavorable opinion on the product design.

Irrespective of the particular form of the feedback received by the system in act 116, in act 118 preference data associated with user 105a is updated based on the received feedback. In some embodiments, such an update may comprise adding and/or subtracting to/from feedback scores associated with values of parameters that were used to generate the product design in act 112. In some implementations, feedback scores may be configured to only increase, such that negative feedback with respect to a parameter value does not cause the feedback score associated with that parameter value to decrease, but rather stay the same. Alternatively, feedback scores may be added to when positive feedback is received and subtracted from when negative feedback is received. It will also be appreciated that mathematical operations other than addition or subtraction may be envisioned, such as multiplying feedback scores by a scaling factor based on feedback, or any other suitable operation.

As a non-limiting example, consider a feedback scheme in which a user can “like” a product design, can “dislike” the product design, or can add the product design to a list of favorites. In the illustrative scheme, these responses are associated with feedback score modifiers of +1, −1 and +3, respectively. A parameter X of the product design may have four possible values, V₁, V₂, V₃ and V₄. A feedback score associated with one of the values V₁, V₂, V₃ and V₄ may be modified according to the response by the user to a product design when the product design was generated using the corresponding value for X For example, if the feedback scores for (V₁, V₂, V₃, V₄)−(5, 11, 2, 3) and a product design is generated using value V₃ for parameter X, the feedback score of 2 associated with value V₃ may be modified by the feedback score modifier associated with the user's response. A “dislike” response to this product design will, for example, produce new feedback scores of (V₁, V₂, V₃, V₄)=(5, 11, 1, 3). In some embodiments, randomly sampling a value of parameter X based on these feedback scores may treat the feedback scores as a probability distribution such that, in the above example after feedback, the probability of each value being selected is P(V₁)=5/20; P(V₂)=11/20; P(V₃)=1/20; and P(V₄)=3/20.

As discussed above, the iterative loop of acts 110, 112, 114, 116 and 118 may continue until a finalized product design has been created. In some cases, each of acts 110, 112, 114, 116 and 118 may be performed only a single time if the initial product design is one that the user 105a chooses to finalize. In general, however, these acts may be performed multiple times prior to finalizing the product design. Finalizing the product design in act 120 may comprise any of numerous different additional steps, examples of which are discussed below. The user 105a may indicate to the system executing acts 110, 112, 114, 116 and 118 that a current product design is to be finalized in any suitable way, including by interacting with the GUI presented by client interface 105b. Such interaction may comprise, for example, activating a control that indicates the design is to be finalized. In some cases, such a control may indicate that the user wishes to purchase the product design (e.g., may be an “add to shopping cart” control). Once a product design has been finalized, method 100 may in some cases be repeated when, for instance, a user wishes to generate a new product design different from the initial finalized product design.

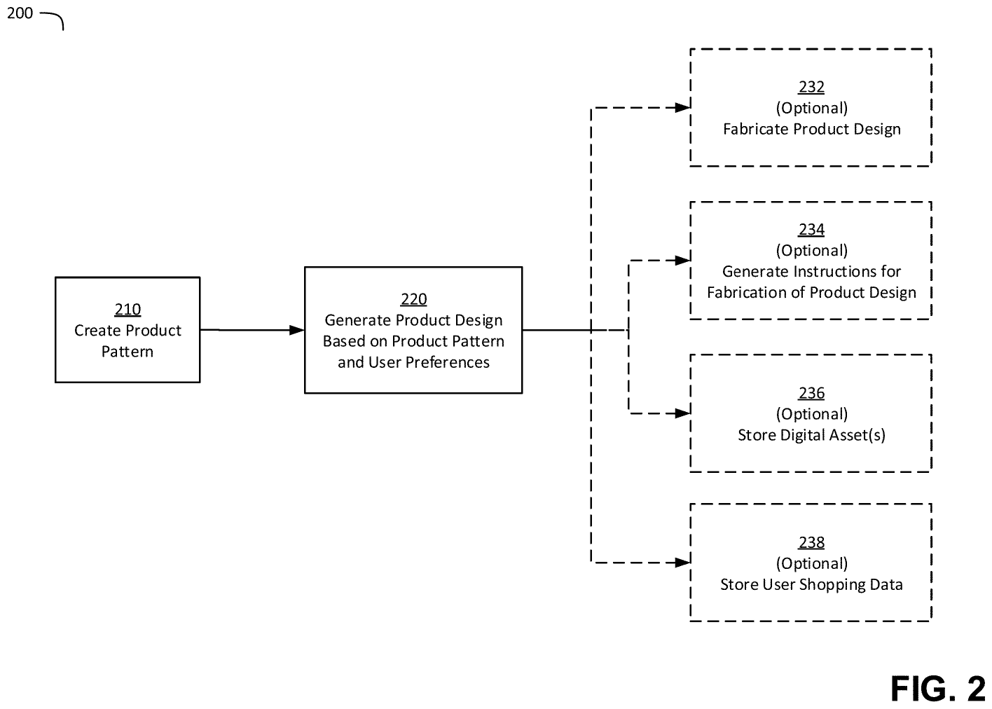

FIG. 2 is a flowchart of a method of producing a product pattern and producing a desired end product based on user preferences, according to some embodiments. Method 200 begins in act 210 in which a product pattern is created. In some embodiments, a product pattern may comprise a program having a number of input parameters, based on which the program generates a representation of a product design using the parameter values when executed. For example, a product pattern may comprise instructions that, when executed, generate a 2- or 3-dimensional model of a product design based on the selected parameter values.

Once the product pattern is created in act 210, any number of product designs may be generated by selecting suitable values for the parameters of the product pattern. Act 220 in method 200 may represent one instance of such a generation process. Act 220 may comprise, for instance, the acts 110, 112, 114, 116 and 118 of method 100 shown in FIG. 1, performed one or more times.

In the example of FIG. 2, four different endpoints for a product design are represented in acts 232, 234, 236 and 238. When performing method 200, any combination of these acts may be performed (including none of the acts).

In act 232, the product design may be physically fabricated. Act 232 may comprise any number and type of physical fabrication steps and may include any suitable combination of manual and/or automated fabrication processes. As one example, portions of the product design may be automatically fabricated via a 3d printer, whereas other portions may be fabricated through conventional woodworking, and the portions assembled into the product design.

In act 234, instructions to fabricate the product design may be generated. The system generating the product design in act 220, and/or a different system, may generate instructions to be supplied to an individual, organization and/or one or more devices that indicate how to fabricate the product design. In some embodiments, such instructions may comprise instructions to be executed by an additive fabrication device or CNC device that, when executed by the device, fabricate some or all of the product design. In some cases, such instructions may be generated based on a particular model or type of additive fabrication device or CNC device that is intended to fabricate some or all of the product design. In some cases, the system that generated the product design may interface with software for generating said instructions, which may be associated with a particular fabrication device or process. For example, the system may generate a three-dimensional model of the product design (or a portion of the product design) and access software for “slicing” the model in preparation for 3d printing. This software (or other software) may then be accessed to generate executable instructions based on the slicing data (e.g., gcode) that can be executed by a 3d printer to fabricate the product design (or portion thereof).

In act 236, one or more digital assets may be stored that are representational of the generated product design. In some embodiments, the product being designed may be entirely digital in nature such that storing assets associated with the product design is the natural end point of such a process. Digital assets may include any number of 3-dimensional and/or 2-dimensional representations, including 3d models, images, textures, shapes, etc. For instance, the product being designed may be generated for the purposes of use purely in a digital application such as online materials (e.g., online marketing materials), a video game and/or in a virtual reality application.

In act 238, data associated with the purchasing behavior of a user may be stored. Such data may comprise preference data generated based on the purchasing behavior, since it may be inferred that a user has a positive opinion of the products he or she has purchased. In addition, or alternatively, data associated with the purchasing behavior of a user may include a record of products purchased. In some cases, preference data may be generated based on a record of products purchased by a user and a new product design generated based on the generated preference data.

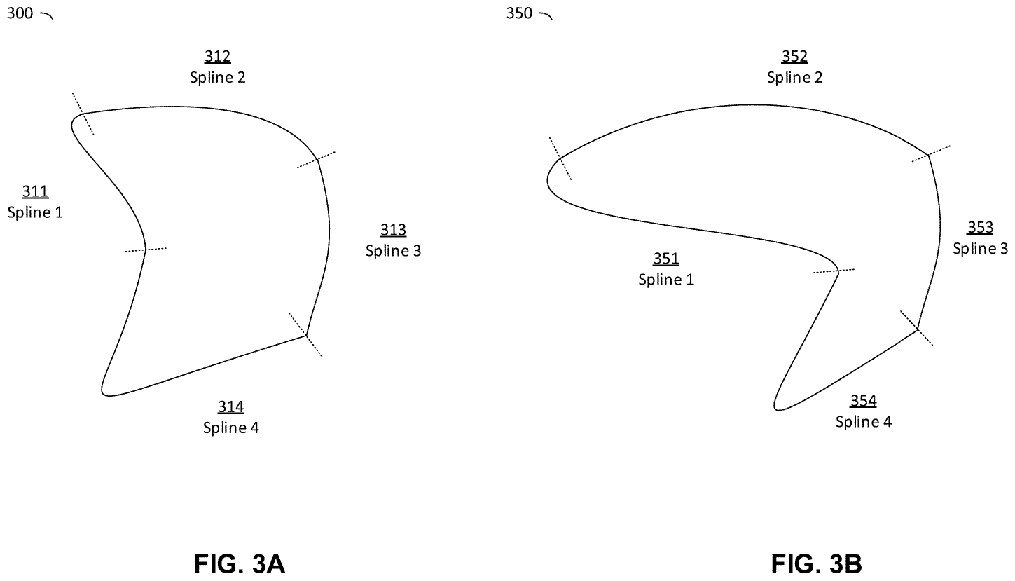

FIGS. 3A-3B depict two-dimensional shapes defined by four interconnected parameterized curves, according to some embodiments. To demonstrate an illustrative portion of a product design process in a visual form, shapes 300 and 350 are depicted in FIGS. 3A and 3B, respectively. In the example of FIGS. 3A-3B, a product pattern comprises a shape that is defined by four splines, which have interconnected start and end points. The product pattern parameterizes the shape via parameters of the splines.

Shape 300 is defined by splines 311, 312, 313 and 314, which have interconnected start and end points (denoted by a dotted line passing through the start/end points). Each of these splines may be parameterized in a number of ways, such that the shape 300 may itself be parameterized. As one example, the splines may be parameterized by the positions of the start and end points and by tangent directions of the curve at each of the start and end points. As another example, the splines may be parameterized by a number of points in the plane through which the curves pass.

Irrespective of how the shape 300 is parameterized, this shape may represent part or all of a product design, such that alteration of the parameters that define the shape 300 via splines 311, 312, 313 and 314 will produce a new shape. One example is shown in FIG. 3B. Shape 350 is also defined by four splines 351, 352, 353 and 354, which have different characteristics than the splines 311, 312, 313 and 314 of shape 300 and are produced by varying the parameters of the splines of shape 300. It will be appreciated that a wide variety of shapes may be generated by adjusting the parameters of the shapes 300 and 350.

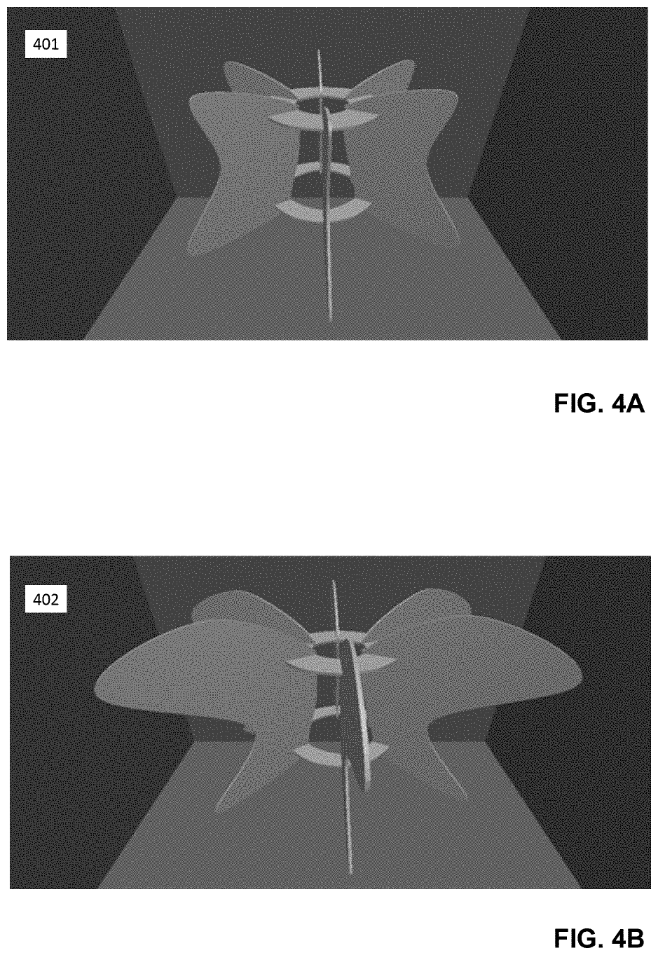

FIGS. 4A-4B depict illustrative product designs comprising the shapes illustrated in FIGS. 3A-3B, according to some embodiments. In the example of FIGS. 4A and 4B, a product is formed from six instances of a shape interconnected with two rings. This shape is parameterizable as discussed above in the example of FIGS. 3A-3B.

Product design 401 shown in FIG. 4A is based on shape 300 shown in FIG. 3A, where planar objects having the shape 300 are spaced around a central axis. Similarly, product design 402 shown in FIG. 4B is based on shape 350 shown in FIG. 3B. The illustrative product designs 401 and 402 may thereby be parameterized by the parameters of the shapes (and hence, their splines) discussed above (although the product pattern from which the product designs 401 and 402 were generated may also include additional parameters not discussed in this example).

While various approaches to join elements of a product design together may be envisioned, one such approach will be described for illustration. A product pattern may specify a number of “pieces,” being flat shapes, and “joins,” being geometric transformations that specify a relationship between the pieces. By applying the joins to the pieces, a product design may be assembled. In this example, each piece may be described by a set of one or more curves, which are each piecewise cubic splines within a common plane. The curves may together describe one connected shape having at least one boundary curve and zero or more other curves that may define holes within the region defined by the boundary. As discussed above, such curves may be parameterized in a number of ways such that each piece may be parameterized based on parameters defining its constituent curves.

While the product pattern may generate an object based on values of these parameters, a creator of the product pattern may specify that only some parameters may be varied, whereas others may have fixed values. In some cases, all parameters may be variable, however. Also, in some cases, parameters may be variable but with certain restrictions. For example, a product pattern may specify that certain parameters may only be varied within a certain range of values, or only along a subset of the degrees of freedom (e.g., a position may be varied along one axis, or more than one axis, but not other axes).

The product pattern may define joins according to a three-dimensional translation and a three-dimensional rotation (e.g., by six parameters) that indicate how to arrange a given piece within a space when generating a product design. In some cases, a join point may be specified for each piece that defines an origin about which the translation and rotation will be performed.

While many different ways to represent and store such a product pattern and its associated parameters may be envisioned, it will be appreciated that many different product designs may be generated according to such a product pattern, including those examples shown in FIGS. 4A and 4B.

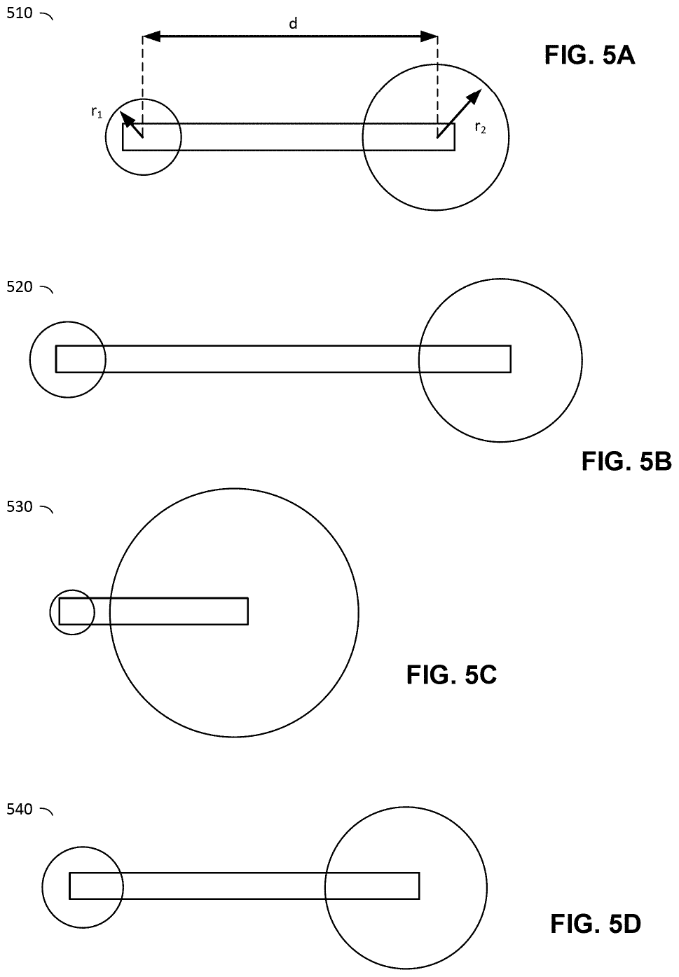

FIG. 5A depicts adjustable spatial attributes of a product, according to some embodiments. To provide an illustrative visual example of meta-parameters, product 510 is defined as a rectangular bar of length d having circular sections of radius r₁ and r₂ at each end of the bar. In the example of FIGS. 5A-5D, the product pattern that parameterizes the product 510 has the following variable parameters: radius_factor_min, radius_factor_range, and length, and defines the following sets of possible values for each of these parameters:

| | |
|---|---|
| radius_factor_min | [0.8, 0.9, 1.0, 1.2, 1.5] |
| radius_factor_range | [0.0, 0.5, 1.0, 1.5] |
| length | [3, 4, 6, 8, 10, 12] |

The product 510 may be parameterized solely by these three parameters, where the radius_factor_min and radius_factor_range parameters define a range of possible values from which values of radius r₁ and radius r₂ may be selected.

In each of the examples of FIGS. 5B, 5C and 5D, to generate a product design according to the product pattern described above, one of the possible values for each of the three parameters is first selected. As discussed above, such a selection may be informed in part by feedback scores associated with each of the values for each parameter. For example, if a user had previously favorably rated a product design in which the length was 8, a random selection of the values for length may be more likely to select 8 as the length.

In the example of FIG. 5B, the system selects the following values of the parameters (e.g., by sampling from a probability distribution in which each value is equally likely, or by sampling from a probability distribution produced according to feedback scores for the values):

radius_factor_min=1.2

radius_factor_range=0.5

length=8

A scaling factor for each of radius r₁ and radius r₂ is determined according to the range of values specified by radius_factor_min and radius_factor_range—in this case, values between 1.2 and 1.7. For the example of product design 520, the scaling factors for radius r₁ and radius r₂ are selected from within that range as 1.36 and 1.51, respectively. These values may be randomly sampled from a probability distribution between 1.2 and 1.7 (e.g., where each value in the range is equally likely, although other probability distributions may also be used). The product pattern for product 510 indicates that base values of the radius r₁ and radius r₂ are 0.5 and 1.0, respectively, such that the final radius values are calculated as:

r₁=base_r1×scaling_r1=0.5×1.36=0.68

r₂=base_r₂×scaling_r2=1.0×1.51=1.51

thereby generating product design 520.

As another example, in FIG. 5C, the system selects the following values of the parameters when generating a product design:

radius_factor_min=0.8

radius_factor_range=1.5

length=3

and scaling factors for radius r₁ and radius r₂ are selected from the range 0.8 to 2.3, yielding scaling factors of 0.85 and 2.29, respectively. According to the product pattern for product 510, the final radius values are therefore calculated as:

r₁=0.5×0.85=0.425

r₂=1.0×2.29=2.29

thereby generating product design 530.

As yet another example, in FIG. 5D, the system selects the following values of the parameters when generating a product design:

radius_factor_min=1.5

radius_factor_range=0.0

length=6

and scaling factors for radius r₁ and radius r₂ are selected from the range 1.5 to 1.5, yielding scaling factors of 1.5 for both radii. According to the product pattern for product 510, the final radius values are therefore calculated as:

r₁=0.5×1.5=0.75

r₂=1.0×1.5=1.50

thereby generating product design 530.

It may be appreciated that a user providing feedback on the various product designs 520, 530 and 540 is not directly providing feedback on whether the user likes or dislikes the size of the circles, but rather is providing feedback on whether the user prefers a large or small variation of the sizes of the circles (via the radius_factor_range parameter) and on a preferred lower bound on the sizes of the circles (via the radius_factor_min parameter). Use of meta-parameters in this manner may thereby allow a user to provide feedback on product options that would otherwise be difficult or impossible to present to the user.

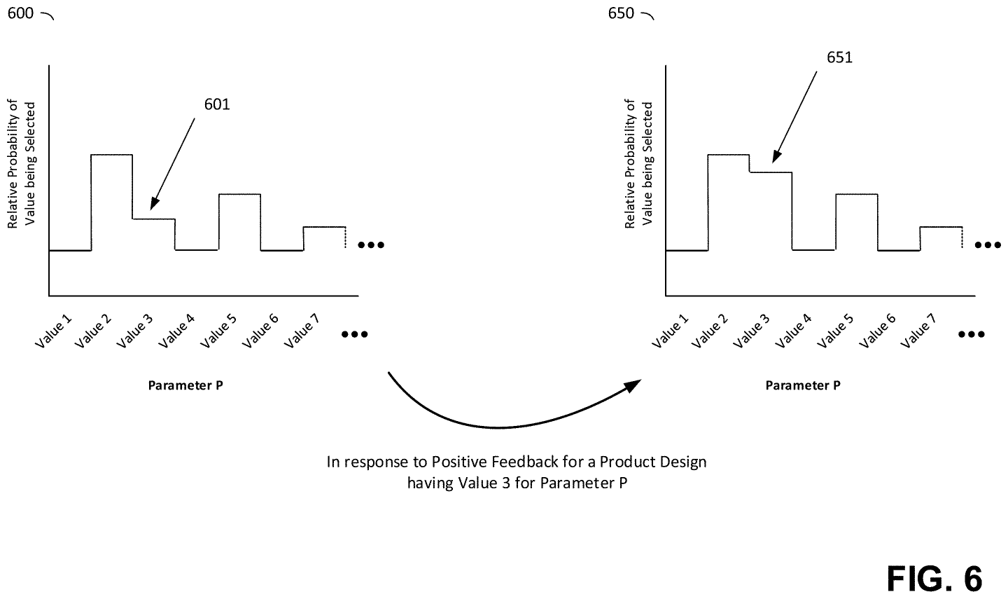

FIG. 6 depicts an illustrative probability distribution for product pattern parameters being updated based on user feedback, according to some embodiments. As discussed above, when generating a product design from a product pattern, values for a given parameter of the product pattern may be selected according to a probability distribution defined by feedback scores for the values for that parameter. Chart 600 in FIG. 6 depicts an illustrative probability distribution that may be defined as such.

A probability distribution for values of a parameter of a product pattern may be determined according to feedback scores in a variety of ways, including by simply treating each feedback score as a relative probability of the associated value being selected and normalizing those scores to sum to 1.

Irrespective of how the depicted probability distribution of chart 600 shown in FIG. 6 was determined, in the example of FIG. 6 a product design is generated wherein the value “Value 3” for parameter P was selected for said generation. This product design is presented to a user (e.g., in act 114 in method 100 shown in FIG. 1) and the user provides positive feedback with respect to the presented product design. As a result, the relative probability of Value 3 being selected as the value of parameter P in the future is increased, as shown by histogram peak 651 in chart 650 (compare with peak 601 in chart 600), whereas the remainder of the illustrative histogram remains as in chart 600.

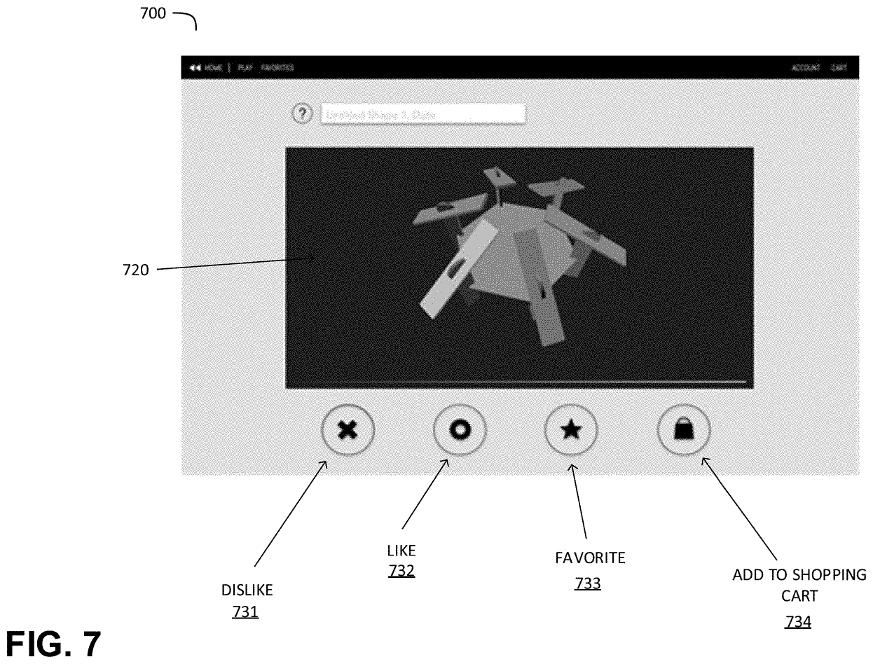

FIG. 7 depicts an illustrative graphical user interface for a user to provide feedback on a design of a product, according to some embodiments. GUI 700 is provided as one illustrative example of a client interface that may be presented to a user in order to obtain feedback from the user on a product design. In FIG. 7, a product design is presented in view 720 and a user may activate one of four controls 731, 732, 733 and 734 based on the extent to which they like the product design. For instance, the controls may be activated through a touch-sensitive display and/or via an input device such as a keyboard or mouse.

In the example of FIG. 7, activation of control 731 indicates that the user dislikes the product design, which may, in some embodiments, subsequently result in the system decreasing feedback scores associated with parameter values from which the product design was generated. Activation of control 732 indicates that the user likes the product design, which may, in some embodiments, subsequently result in the system increasing feedback scores associated with parameter values from which the product design was generated. Activation of control 733 indicates that the user wants to add the product design to a list of favorites, which may, in some embodiments, subsequently result in the system increasing feedback scores associated with parameter values from which the product design was generated. Activation of control 734 indicates that the user wants to add the product design to their shopping cart, which may, in some embodiments, subsequently result in the system increasing feedback scores associated with parameter values from which the product design was generated. In some embodiments, increases in feedback scores made by the system in response to activation of control 732, 733 or 734 may differ so that, for example, identifying a product design as a favorite results in a greater increase to feedback scores than increases in feedback scores made as a result of selecting control 732.

The example of FIG. 7 is provided as one illustrative technique by which input from a user may be provided to indicate feedback on a product design. Other input methods may also (or additionally) be employed such as via sensors or other devices to track a position and/or motion of a user. For example, eye trackers may provide input indicative of feedback on a product design by identifying where a user's gaze is directed.

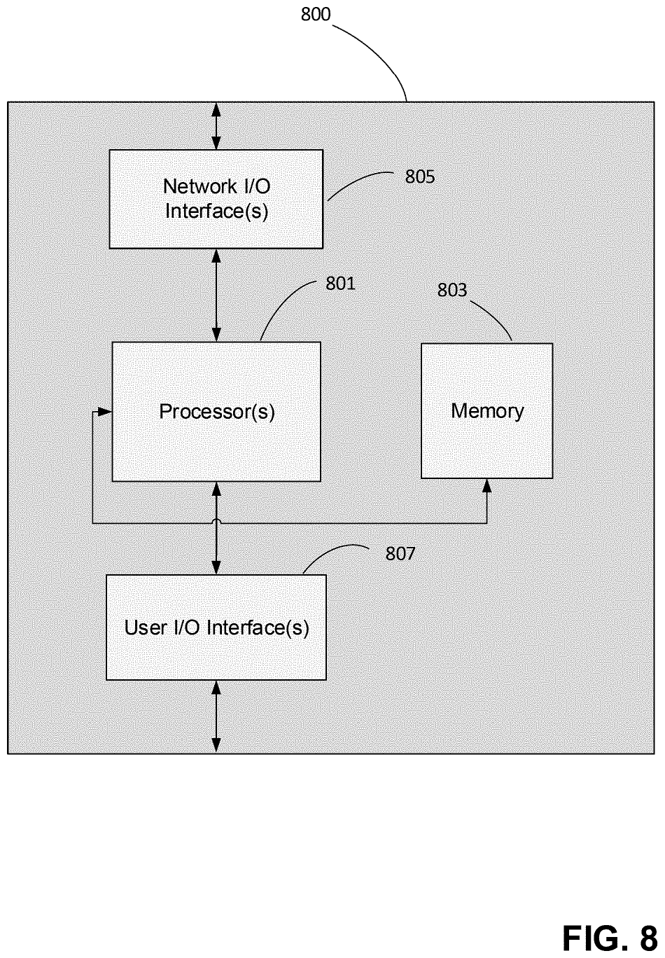

FIG. 8 is a block diagram of an illustrative computing device 800 that may be used to implement any of the above-described techniques. Computing device 800 may include one or more processors 801 and one or more tangible, non-transitory computer-readable storage media (e.g., memory 803). Memory 803 may store, in a tangible non-transitory computer-recordable medium, computer program instructions that implement any of the above-described functionality. Processor(s) 801 may be coupled to memory 803 and may execute such computer program instructions to cause the functionality to be realized and performed.

Computing device 800 may also include a network input/output (I/O) interface 805 via which the computing device may communicate with other computers (e.g., over a network), and may also include one or more user I/O interfaces 807, via which the computer may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-recordable medium (e.g., a computer memory, a floppy disk, a compact disk, a magnetic tape, or other tangible, non-transitory computer-recordable medium) encoded with a computer program (i.e., a plurality of instructions) which, when executed on one or more processors, performs the above-discussed functions of one or more embodiments of the present invention. The computer-recordable medium can be transportable such that the program stored thereon can be loaded onto any computer resource to implement aspects of the present invention discussed herein. In addition, it should be appreciated that the reference to a computer program which, when executed, performs any of the above-discussed functions, is not limited to an application program running on a host computer. Rather, the term computer program is used herein in a generic sense to reference any type of computer code (e.g., software or microcode) that can be employed to program one or more processors to implement above-discussed aspects of the present invention.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented method of dynamically designing a product according to a product pattern, the product pattern describing a product based on a plurality of parameters, the method comprising:
selecting, using at least one processor, values for each of the plurality of parameters of the product pattern, said selecting including selecting an initial value for a first parameter of the plurality of parameters based on a first probability distribution of possible values for the first parameter, the first probability distribution being defined at least in part by a plurality of feedback scores each associated with the possible values for the first parameter;
generating, using the at least one processor, a first product design according to the product pattern and based on the selected initial value for the first parameter;
presenting, using the at least one processor, the first product design to a user via a user interface;
receiving input, using the at least one processor, from the user via the user interface indicating a favorable or unfavorable opinion with respect to the first product design;
adjusting, using the at least one processor, at least one of the plurality of feedback scores based on the received input; and
selecting, using the at least one processor, a subsequent value for the first parameter of the plurality of parameters based on a second probability distribution of possible values for the first parameter, the second probability distribution being defined at least in part by the plurality of feedback scores as adjusted based on the received input.

2. The method of claim 1, further comprising fabricating the product design via one or more additive fabrication devices.

3. The method of claim 1, wherein selecting the initial value for the first parameter comprises randomly sampling from the first probability distribution, and wherein the first probability distribution is proportional to a distribution of the plurality of feedback scores.

4. The method of claim 1, wherein the user interface is a graphical user interface presented through a display of a mobile device.

5. The method of claim 1, wherein the at least one processor is part of a server system and wherein the user interface is presented via a client system.

6. The method of claim 1, wherein generating the first product design comprises executing, by the at least one processor, executable instructions of the product pattern to which the initial value of the first parameter is supplied as input.

7. The method of claim 1, wherein generating the first product design comprises determining, by the at least one processor, shapes of a plurality of portions of the product design and joining said shapes based on the values for the plurality of parameters of the product pattern.

8. The method of claim 1, wherein the first parameter parameterizes a shape of a spline.

9. The method of claim 1, wherein the first parameter defines a size of an element of the product design.

10. The method of claim 1, further comprising obtaining preference data associated with the user, and wherein the first probability distribution is further defined based on the obtained preference data.

11. At least one non-transitory computer readable medium comprising instructions that, when executed by at least one processor, perform a method of dynamically designing a product according to a product pattern, the product pattern describing a product based on a plurality of parameters, the method comprising:
selecting values for each of the plurality of parameters of the product pattern, said selecting including selecting an initial value for a first parameter of the plurality of parameters based on a first probability distribution of possible values for the first parameter, the first probability distribution being defined at least in part by a plurality of feedback scores each associated with the possible values for the first parameter;
generating a first product design according to the product pattern and based on the selected initial value for the first parameter;
presenting the first product design to a user via a user interface;
receiving input from the user via the user interface indicating a favorable or unfavorable opinion with respect to the first product design;
adjusting at least one of the plurality of feedback scores based on the received input; and
selecting a subsequent value for the first parameter of the plurality of parameters based on a second probability distribution of possible values for the first parameter, the second probability distribution being defined at least in part by the plurality of feedback scores as adjusted based on the received input.

12. The at least one non-transitory computer readable medium of claim 11, wherein selecting the initial value for the first parameter comprises randomly sampling from the first probability distribution, and wherein the first probability distribution is proportional to a distribution of the plurality of feedback scores.

13. The at least one non-transitory computer readable medium of claim 11, wherein generating the first product design comprises executing executable instructions of the product pattern to which the initial value of the first parameter is supplied as input.

14. The at least one non-transitory computer readable medium of claim 11, wherein generating the first product design comprises determining shapes of a plurality of portions of the product design and joining said shapes based on the values for the plurality of parameters of the product pattern.

15. The at least one non-transitory computer readable medium of claim 11, wherein the first parameter parameterizes a shape of a spline.

16. The at least one non-transitory computer readable medium of claim 11, wherein the first parameter defines a size of an element of the product design.

17. The at least one non-transitory computer readable medium of claim 11, wherein the method further comprises obtaining preference data associated with the user, and wherein the first probability distribution is further defined based on the obtained preference data.

18. A system, comprising:
at least one processor;
at least one non-transitory computer readable medium comprising instructions that, when executed by the at least one processor, perform a method of dynamically designing a product according to a product pattern, the product pattern describing a product based on a plurality of parameters, the method comprising:
selecting values for each of the plurality of parameters of the product pattern, said selecting including selecting an initial value for a first parameter of the plurality of parameters based on a first probability distribution of possible values for the first parameter, the first probability distribution being defined at least in part by a plurality of feedback scores each associated with the possible values for the first parameter;
generating a first product design according to the product pattern and based on the selected initial value for the first parameter;
presenting the first product design to a user via a user interface;
receiving input from the user via the user interface indicating a favorable or unfavorable opinion with respect to the first product design;
adjusting at least one of the plurality of feedback scores based on the received input; and
selecting a subsequent value for the first parameter of the plurality of parameters based on a second probability distribution of possible values for the first parameter, the second probability distribution being defined at least in part by the plurality of feedback scores as adjusted based on the received input.

19. The system of claim 18, wherein generating the first product design comprises determining shapes of a plurality of portions of the product design and joining said shapes based on the values for the plurality of parameters of the product pattern.

20. The system of claim 18, wherein the method further comprises obtaining preference data associated with the user, and wherein the first probability distribution is further defined based on the obtained preference data.
